(19) United States
(12) Patent Application Publication
(10) Pub. No.: US 2013/0067393 A1
(43) Pub. Date: Mar. 14, 2013

(54) Interaction with Lists

(71) Applicants: Ryan J. Demopoulos, Bellevue, WA (US); Christine C. Stawitz, Seattle, WA (US); Nitin Sharma, Pasadena, CA (US); Moneta Ho Kushner, Bellevue, WA (US); Evan S. Wirt, Redmond, WA (US); Matthew J. Esquivel, Sammamish, WA (US)

(72) Inventors: Ryan J. Demopoulos, Bellevue, WA (US); Christine C. Stawitz, Seattle, WA (US); Nitin Sharma, Pasadena, CA (US); Moneta Ho Kushner, Bellevue, WA (US); Evan S. Wirt, Redmond, WA (US); Matthew J. Esquivel, Sammamish, WA (US)

(21) Appl. No.: 13/230,022

(22) Filed: Sep. 12, 2011

(51) Int. Cl. G06F 3/048

(52) U.S. Cl. 715/784

(57) ABSTRACT

Techniques for interaction with lists are described. In implementations, a wrapped list window is presented in response to an item being selected that enables a user to navigate (e.g., via panning and/or scrolling) a list of items to view other selectable items. In at least some embodiments, a user can select the item and navigate the list via a single interaction. In implementations, a list separator is implemented in a wrapped list that delineates a separation between a last item in a list of items and a first item in the list. Further to implementations, logic is employed to determine whether to display a list of items as a linear list or a wrapped list. The logic can further specify rules for determining how to configure specific types of lists on a display screen.

### BACKGROUND

A graphical user interface typically includes some form of list from which items can be selected. For example, a word processing application can present a list of fonts, from which a user can select a desired font. Current list configurations, however, are non-intuitive and often cause a user shift their focus in order to navigate a list. Additionally, a user may become disoriented when trying to navigate a list with many items.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for interaction with lists are described. In implementations, a selectable item is displayed on a display screen. In response to a selection of the selectable item, a list window is presented that a user can navigate (e.g., via panning and/or scrolling) to view other selectable items. For example, the selectable item can be selected via touch selection, mouse-initiated selection, keyboard-initiated selection, and so on. In at least some embodiments, the list window presents a wrapped list of items that is centered on the selectable item. Thus, a user can select the selectable item and navigate the list via a single interaction.

In implementations, a list separator is implemented in a wrapped list that delineates a separation between a last item in a list of items and a first item in the list. The list separator can provide a visual reference point within the wrapped list to provide a user with perspective as to their position while navigating the wrapped list.

Further to implementations, logic is employed to determine whether to display a list of items on a display screen as a linear list or a wrapped list. The logic can consider the number of items in the list, as well as a size of the display screen. The logic can further specify rules for determining how to configure specific types of lists on a display screen.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 illustrates an example list scenario in accordance with one or more embodiments.

FIG. 3 illustrates an example list scenario in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 illustrates an example list positioning scenario in accordance with one or more embodiments.

FIG. 7 illustrates an example list positioning scenario in accordance with one or more embodiments.

FIG. 8 is a flow diagram that describes the steps in a method in accordance with one or more embodiments.

FIG. 9 illustrates an example list positioning scenario in accordance with one or more embodiments.

FIG. 10 is a flow diagram that describes steps in a method in accordance with one or more embodiments.

FIG. 11 is an illustration of a system in an example implementation showing FIG. 1 in greater detail.

FIG. 12 illustrates an example computing device that can be utilized to implement various embodiments described herein.

### DETAILED DESCRIPTION

Overview

Techniques for interaction with lists are described. In implementations, a selectable item is displayed on a display screen. In response to a selection of the selectable item, a list window is presented that a user can navigate (e.g., via panning and/or scrolling) to view other selectable items. For example, the selectable item can be selected via touch selection, mouse-initiated selection, keyboard-initiated selection, and so on. In at least some embodiments, the list window presents a wrapped list of items that is centered on the selectable item. Thus, a user can select the selectable item and navigate the list via a single interaction.

In implementations, a list separator is implemented in a wrapped list that delineates a separation between a last item in a list of items and a first item in the list. The list separator can provide a visual reference point within the wrapped list to provide a user with perspective as to their position while navigating the wrapped list.

Further to implementations, logic is employed to determine whether to display a list of items on a display screen as a linear list or a wrapped list. The logic can consider the number of items in the list, as well as a size of the display screen. The logic can further specify rules for determining how to configure specific types of lists on a display screen.

In the following discussion, an example environment is first described that is operable to employ interaction with lists techniques described herein. Next, a section entitled “Wrapped List Interactions” describes example interactions with wrapped lists in accordance with one or more embodiments. Following this, a section entitled “Wrapped and Linear Lists” describes example implementations in which a determination is made whether to use a wrapped list or a linear list. Next, a section entitled “Positioning Linear Windows” describes example ways of determining how to position a linear window in accordance with one or more embodiments. Following this, a section entitled “Positioning Wrapped Windows” describes example ways of determining how to position a wrapped window in accordance with one or more embodiments. Last, a section entitled “Example System and Device” describes aspects of an example system and an example device that can be utilized to implement one or more embodiments.

Example Environment

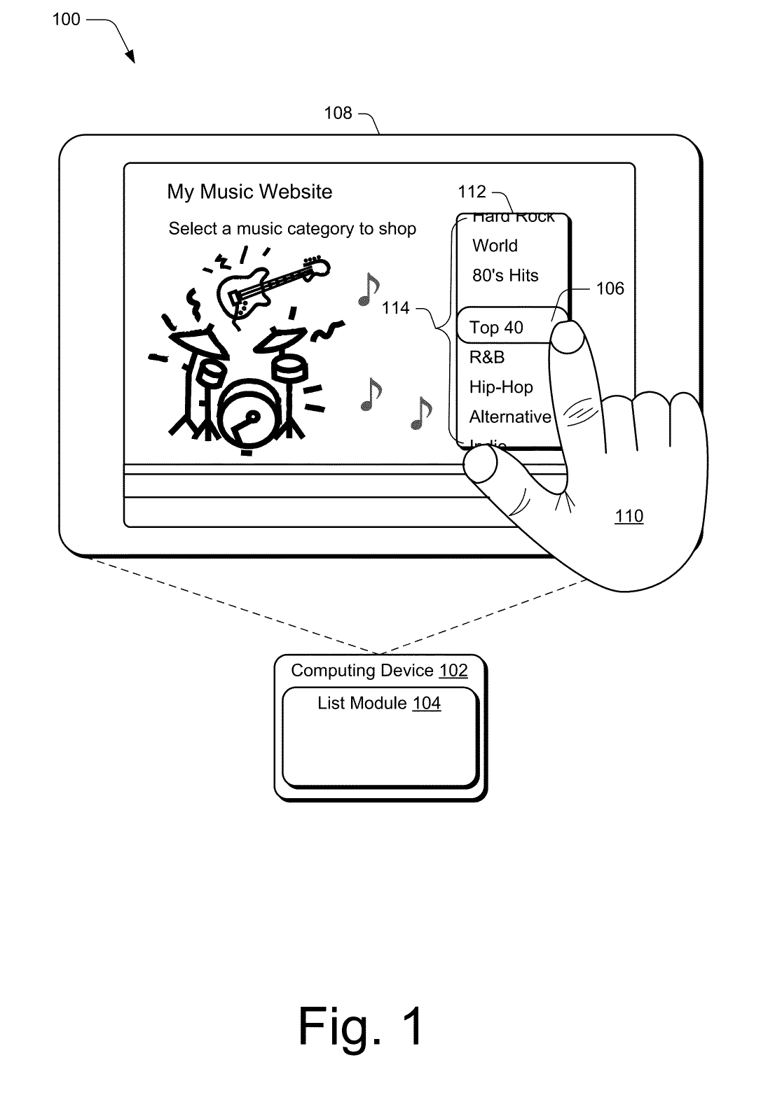

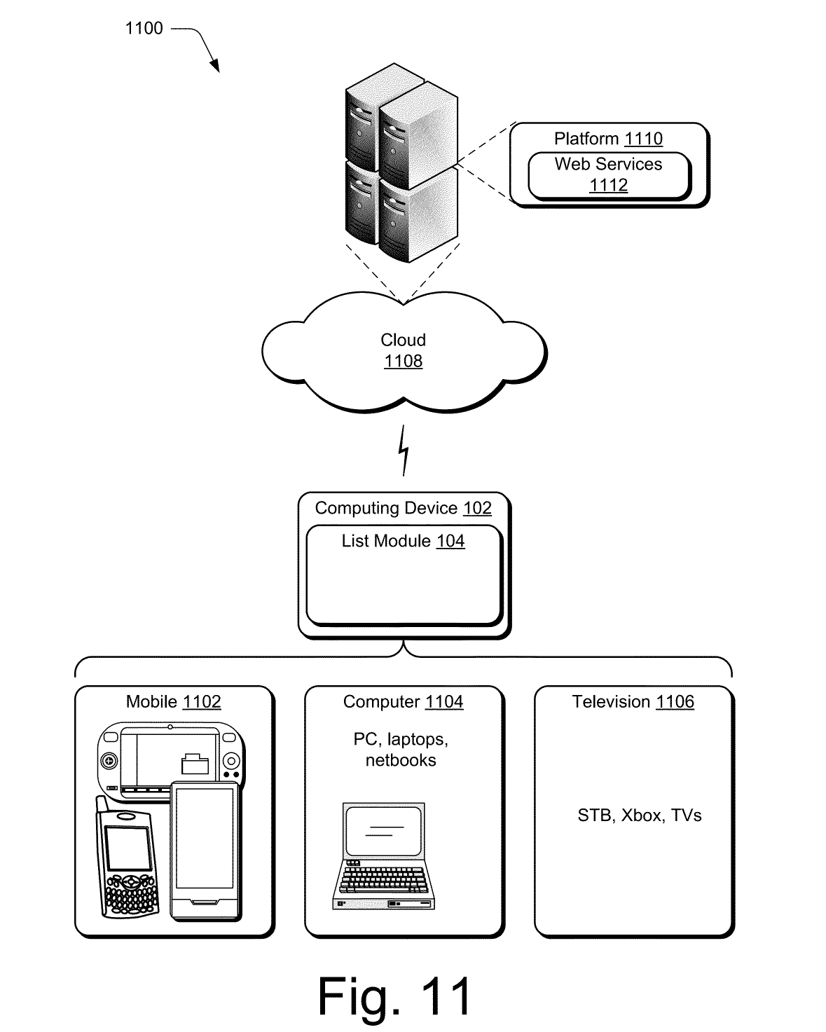

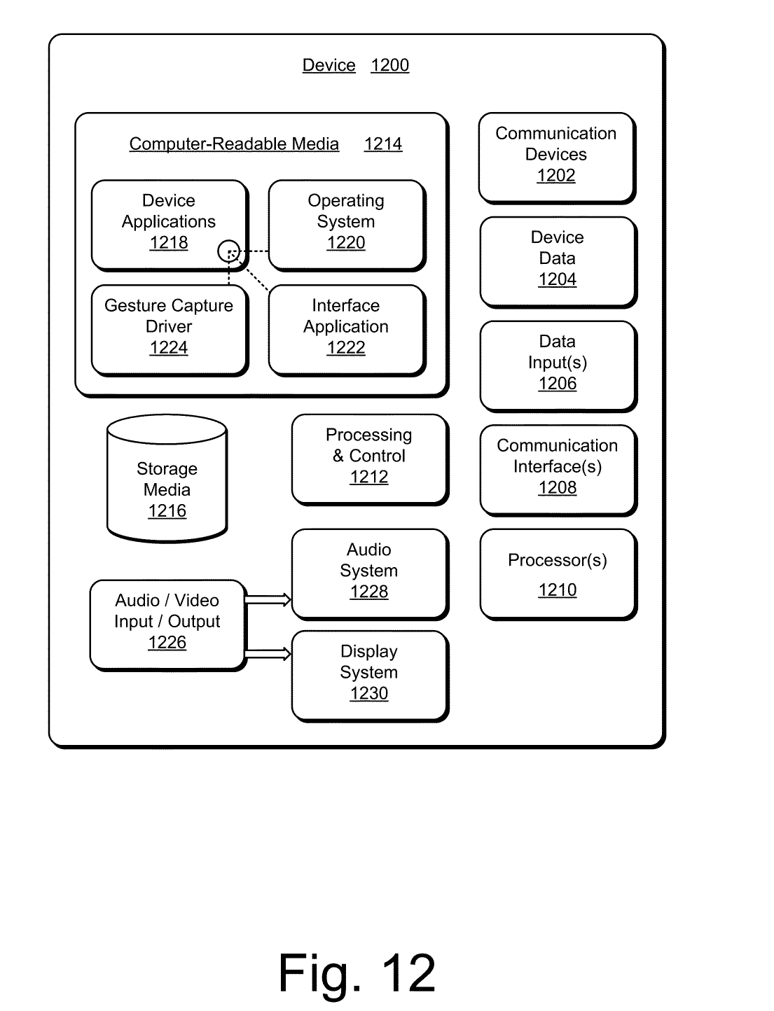

FIG. 1 is an illustration of an environment 100 in an example implementation that is operable to employ techniques for interaction with lists described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIGS. 11 and 12. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a list module 104 that is operational to provide techniques for interaction with lists as described in this document. The list module 104 can be implemented in connection with any suitable type of hardware, software, firmware or combination thereof. In at least some embodiments, the list module 104 is implemented in software that resides on some type of tangible, computer-readable storage medium examples of which are provided below.

The list module 104 is representative of functionality to recognize a user interaction with a selectable item, cause a list of related selectable items to be presented, and enable a user to navigate through the list. The list module 104 employs logic to determine appropriate list types and configurations to be presented, and examples of such logic are discussed below. For example, based on the number of items to be presented in a list and/or a position of a list on a display screen, the list module 104 can present either a “wrapped list” or a “linear list.” Aspects of wrapped lists and linear lists are explained in detail below.

In the environment 100, a selectable item 106 is illustrated as being displayed via a display device 108 included as part of the computing device 102. A finger of a user's hand 110 selects the selectable item 106, which causes a list window 112 to be displayed. The list window 112 includes list items 114, which can be scrolled through the list window to enable a user to view and select from available list items. The list items 114 are presented in the list window 112 as a “wrapped list” such that a particular list item can scroll out of the list window at one edge (e.g., the bottom edge) and scroll back into the list window at another edge, e.g., the top edge. Thus, a user can scroll through the list items 114 multiple times by manipulating the list items in one direction. Further aspects of list presentation and interaction are discussed below.

While embodiments are discussed herein with reference to scrolling and/or panning visual items in a user interface, it is to be appreciated that any type of manipulation and/or navigation of visual items may be employed within the spirit and scope of the claimed embodiments.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the interaction with lists techniques described below are platform-independent, meaning that the techniques may be implemented on a variety of commercial computing platforms having a variety of processors.

Discussed below are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100 and below with reference to the system 1100.

Having discussed an example environment, consider now some example wrapped list interactions in accordance with one or more embodiments.

Wrapped List Interactions

In one or more embodiments, a wrapped list is presented that displays a visually looped list of items such that a user can scroll through the list multiple times via manipulation of the list in a single direction.

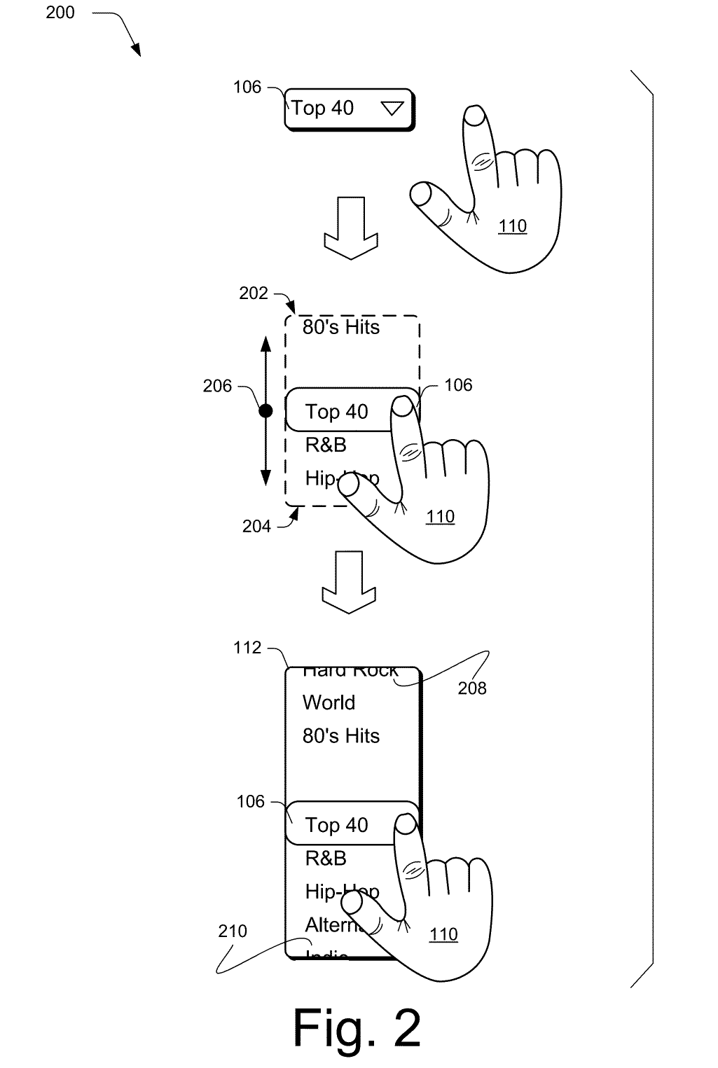

As an example, consider FIG. 2 which illustrates a list scenario 200 in accordance with one or more embodiments. In the top portion, the selectable item 106 is displayed. Continuing to the center portion, a finger of the user's hand 110 selects the selectable item 106, which initiates drawing of the list window 112. The center portion of the list scenario 200 illustrates that the list window 112 is drawn as a centered list with reference to the selectable item 106. For example, when the list window 112 is drawn, a top edge 202 and a bottom edge 204 animate outwardly at approximately the same rate from a center point 206 relative to the selectable item 106.

Continuing to the bottom portion, drawing of the list window 112 is completed. The completed list window 112 includes cropped item 208 at the top, and a cropped item 210 at the bottom. Displaying certain list items as cropped at the top and bottom edges of the list window 112 presents a visual reinforcement that the list is wrapped and that additional items may be viewed by navigating (e.g., scrolling and/or panning) the list items. A user can navigate through the list items of the list window 112, such as by scrolling the list items upward and/or downward through the list window. Thus, the list scenario 200 illustrates that the list window 112 is drawn “around” the selectable item 106 such that a user can select the selectable item and initiate navigation through the list items with a single touch interaction.

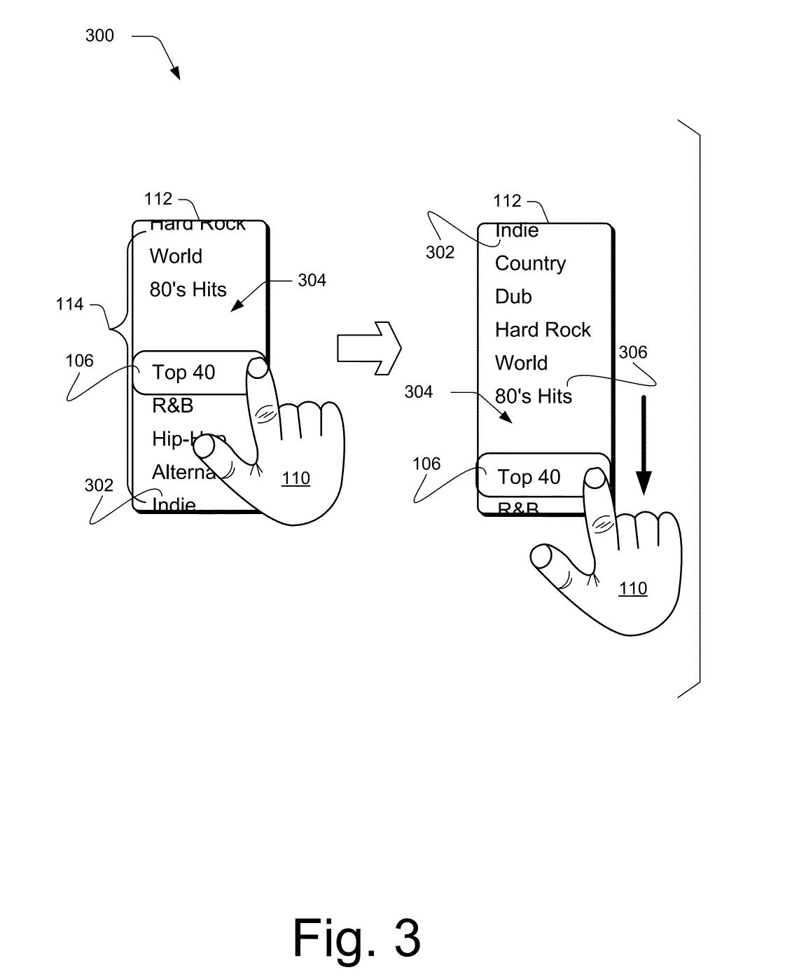

As an example of navigation through items of a wrapped list, consider FIG. 3, which illustrates a list scenario 300 in accordance with one or more embodiments. In the left portion, a finger of the user's hand 110 is in contact with the list items 114, e.g., the selectable item 106. Continuing to the right portion, the finger of the user's hand 110 scrolls the list items downward through the list window 112, such as by dragging their finger downward across the list window. Scrolling the list items causes some of the list items to leave the list window 112 at the bottom, and others of the list items to enter the list window from the top.

For example, consider a list item 302. As part of scrolling the list items from the left portion of the list scenario 300 to the right portion, the list item 302 leaves the list window 112 at the bottom and reenters the list window at the top. Thus, the list items are illustrated as a continuous loop of items that can be scrolled, upward and/or downward, through the list window 112.

Further illustrated in the list scenario 300 is a list separator 304, which is representative of a blank separation object that denotes a separation between a first item of the list items 114 (e.g., the selectable item 106), and a last item of the list items, e.g., a selectable item 306. The list separator 304 presents a visual reference point within the list items 114 to enable a user to understand when they have scrolled through an entire list of items. For example, if the user scrolls the list items 114 such that the list separator 304 leaves the bottom of the list window 112 and then reenters the top of the list window 112, this indicates that the user has scrolled through the entirety of the list items. While the list separator 304 is illustrated as a blank item (e.g., a null item), this is not intended to be limiting. For example, any suitable item that can denote a separation between portions of a list may be utilized within the spirit and scope of the claimed embodiments.

In implementations, the list separator 304 can be associated with “speed bump” functionality that affects the rate at which the list items 114 are scrolled within the list window 112. For example, when the list items 114 are scrolled downward through the list window 112 such that the list separator 304 reaches the bottom of the list window, the speed with which the list items 114 are scrolled can slow and/or the scrolling can temporarily stop. In implementations, the scrolling can slow and/or stop even if a user interaction that causes the scrolling continues. Thus, in this scenario the slowing and/or stopping can provide an indication that the end of the list items 114 (e.g., the selectable item 306) has reached the bottom of the list window 112.

Similarly, the speed bump functionality can be applied to movement of the list items 114 in other directions, such as scrolling upward through the list window 112. For example, scrolling of the list items 114 upward through the list window 112 can be slowed and/or stopped when the list separator 304 reaches the top of the list window 112. This can indicate that a first item of the list items 114 (e.g., the selectable item 106) has reached the top of the list window 112. Thus, the speed bump functionality can be applied to navigation of list items in a variety of different directions to provide a perceptible indication of positions of particular portions of a list.

In implementations, the interactions with the selectable item 106 and the list window 112 illustrated in the list scenarios 200 and 300 can occur in response to a single user touch interaction. For example, a user can touch the selectable item 106 to cause the list window 112 to be presented, as illustrated in the list scenario 200. Without lifting their finger, the user can scroll through the list items in the list window 112, as illustrated in the list scenario 300. The user can then select an item from the list of items, e.g., by touching the item. If a user touches outside of the list window 112 without making a selection, the list window will collapse around the selectable item 106. Thus, embodiments provide quick and intuitive ways of viewing and interacting with a list of items.

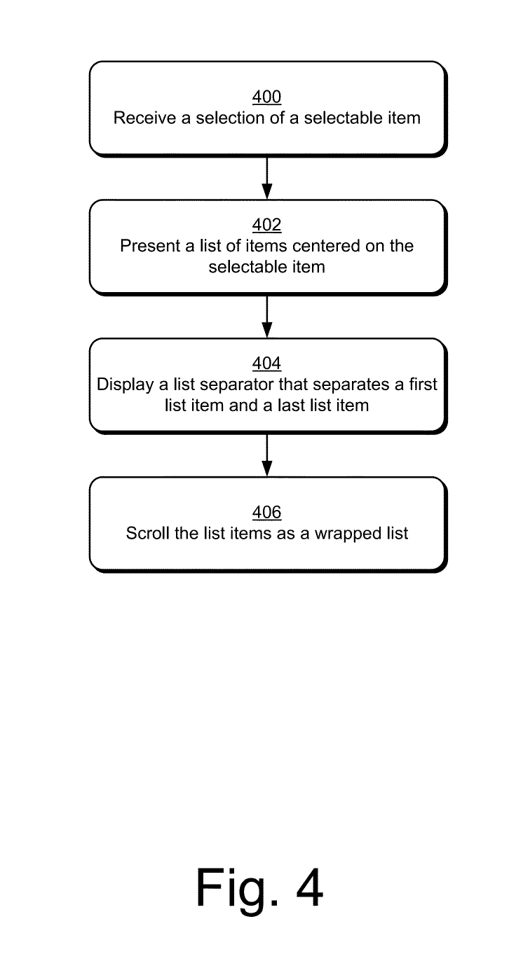

FIG. 4 is a flow diagram that describes steps in a method in accordance with one or more embodiments. In at least some embodiments, the method can be implemented by a list module, such as the one described in FIG. 1. Step 400 receives a selection of a selectable item. For example, the selectable item can be selected via touch selection, mouse selection, keyboard selection, and so on. Step 402 displays a list of items centered on the selectable item. Example ways of displaying list items in a list window are discussed in detail below.

Step 404 presents a list separator that separates a first list item and a last list item. Step 406 scrolls the list items as a wrapped list. For example, the list items can be scrolled in response to user input, such as touch input, mouse input, keyboard input, and so on. As discussed above, the selectable item can be selected and the list items can be scrolled in response to a single user touch interaction.

Having discussed some example wrapped list interactions, consider now some example implementations that can use wrapped and linear lists in accordance with one or more embodiments.

Wrapped and Linear Lists

As mentioned above, embodiments can utilize both wrapped and linear lists. A linear list refers to a list that does not wrap within a list window, e.g., where list items are navigable in a linear fashion and not as a recurring loop. To determine whether to utilize a wrapped list or a linear list in a given scenario, logic is employed that considers a variety of factors. Examples of such logic are discussed hereafter in accordance with one or more embodiments.

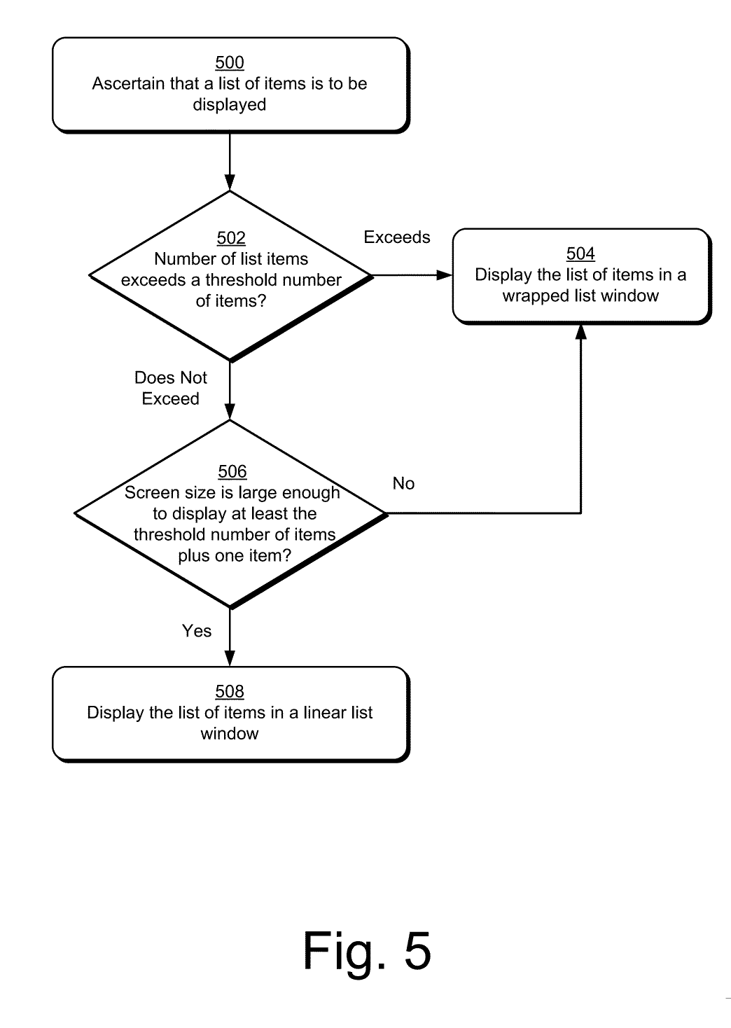

FIG. 5 is a flow diagram that describes steps in a method in accordance with one or more embodiments. In at least some embodiments, the method can be implemented by a list module, such as the one described in FIG. 1. Step 500 ascertains that a list of items is to be displayed. For example, a selectable item can be selected by a user which causes an indication to display a list of other selectable items, as discussed elsewhere herein.

Step 502 determines whether a number of list items exceeds a threshold number of items. For example, the threshold can be based on a display screen size for a given device. A smart phone has a smaller display area than a desktop computer, and thus the smart phone may have a smaller threshold number of list items than does the desktop computer. If the number of list items exceeds the threshold (“Exceeds”), step 504 displays the list items in a wrapped list window.

If the number of list items does not exceed the threshold (“Does Not Exceed”), step 506 determines whether a screen size is large enough to display at least the threshold number of items plus one item. If the screen size is not large enough to display the threshold number of items plus one item, step 504 displays the list items in a wrapped list window. In implementations, allowing for the “plus one item” can prevent the list items from being visually clipped on a display screen when the list items are displayed around a selected item.

Returning to step 506, if the screen size is large enough to display the threshold number of items plus one item, step 508 displays the list items in a linear list window.

Having discussed some example implementations that can use wrapped and linear lists, consider now some example implementations that position linear windows in accordance with one or more embodiments.

Positioning Linear Windows

The positioning of a linear list window in a user interface can depend on a number of factors, such as the number of items in a list, a region of the display screen in which the linear list window is to be drawn, and so on. Thus, logic can be employed to determine how a linear list window is to be drawn in a given scenario.

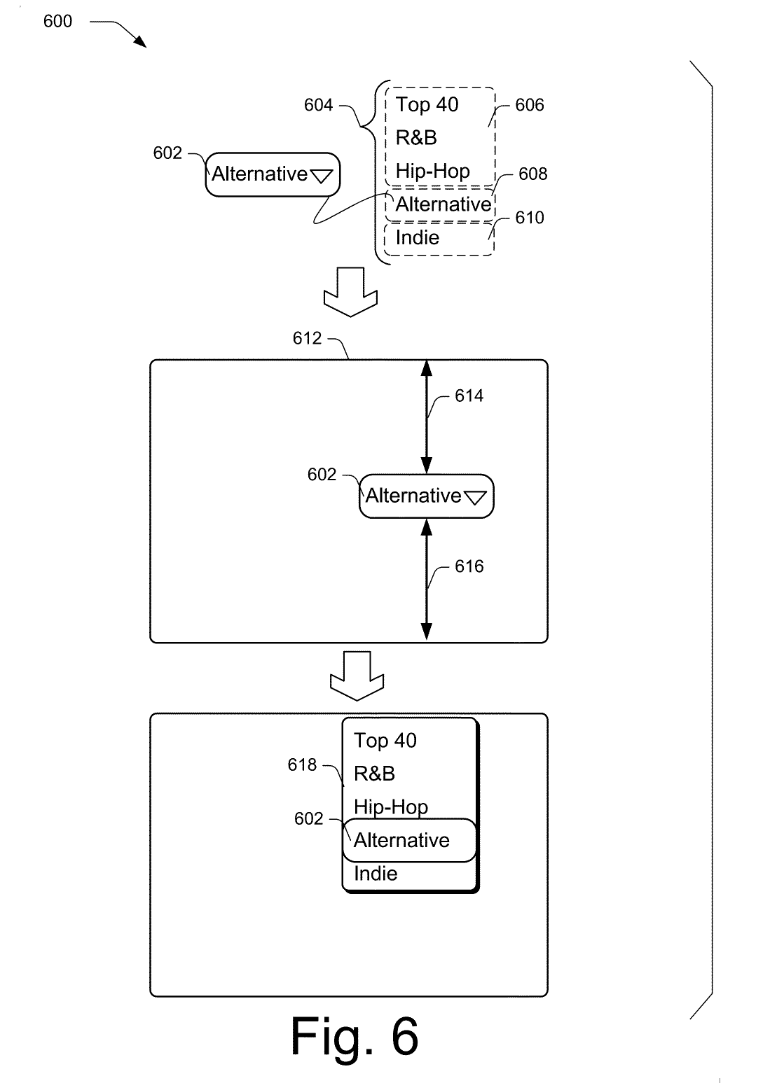

FIG. 6 illustrates an example list positioning scenario 600 in accordance with one or more embodiments. Illustrated at the top portion of the list positioning scenario 600 is a selectable item 602, which is part of a list of items 604. The list items 604 are divided into three zones. A zone 606 includes list items that are positioned above the selectable item 602 in the list items 604. A zone 608 refers to the position of the selectable item 602 in the list items 604. Finally, a zone 610 includes list items that are positioned below the selectable item 602 in the list items 604. The illustrated zones are presented for purpose of example only, and any suitable type and/or size of zone may be implemented in accordance with the claimed embodiments.

Continuing to the center portion of the list positioning scenario 600, the selectable item 602 is displayed on a display screen 612, e.g., included as part of the computing device 102. In response to a selection of the selectable item 602, a determination is made where to position a linear list window that includes the list items 604. As discussed above, a linear list window displays list items such that the list items can be navigated in a linear, non-wrapping manner.

To determine where to position the linear list window, a region 614 between the top edge of the selectable item 602 and the top edge of the display screen 612 is measured. Additionally, a region 616 between the bottom edge of the selectable item 602 and the bottom edge of the display screen 612 is measured. In this example, the region 614 is sufficiently large to accommodate the zone 606, and the region 616 is sufficiently large to accommodate the zone 610. Thus, at the bottom portion of the list positioning scenario 600, a linear list window 618 is displayed such that the position of the selectable item 602 in the list items 604 remains unchanged from its position prior to be selected. For example, the linear list window is drawn on top of the selectable item 602, and the selectable item 602 retains its pre-selection position in the display screen 612.

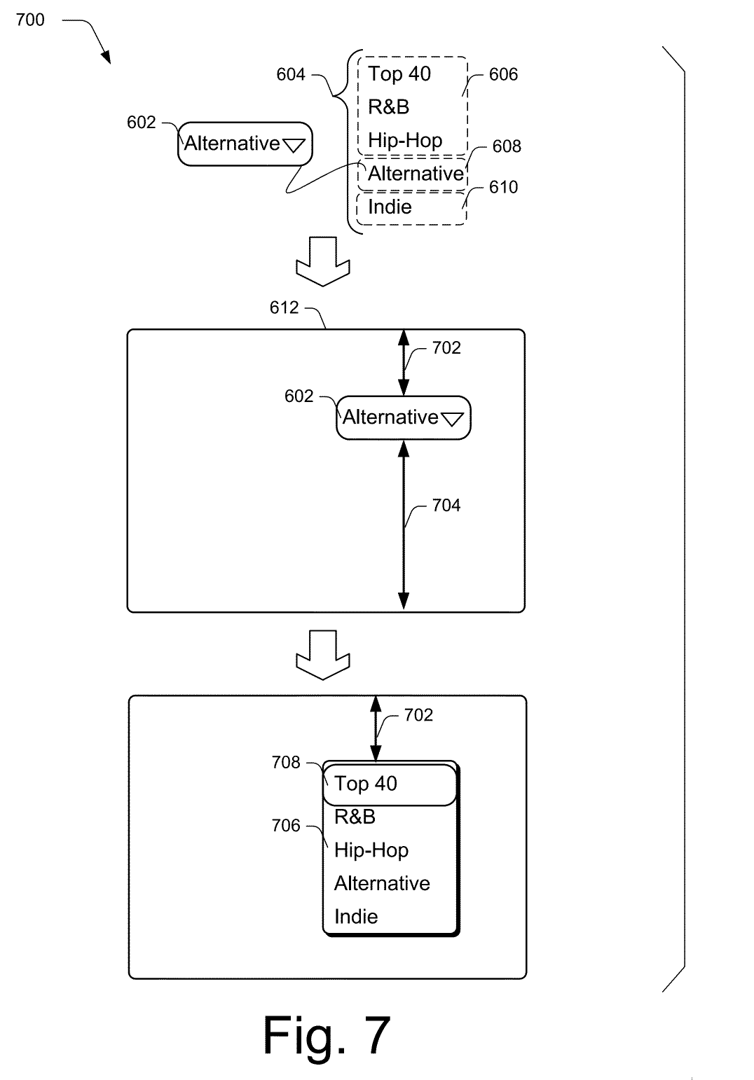

FIG. 7 illustrates an example list positioning scenario 700 in accordance with one or more embodiments. The top portion of the list positioning scenario 700 includes the selectable item 602, along with the list items 604 and their respective zones. Continuing to the center portion of the list positioning scenario 700, the selectable item 602 is displayed at a different position on the display screen 612 than illustrated in the list positioning scenario 600, above. In response to a selection of the selectable item 602, a determination is made where to position a linear list window that includes the list items 604.

To determine where to position the linear list window, a region 702 between the top edge of the selectable item 602 and the top edge of the display screen 612 is measured. Additionally, a region 704 between the bottom edge of the selectable item 602 and the bottom edge of the display screen 612 is measured. In this example, the region 702 is too small to accommodate the zone 606 but the region 704 is sufficiently large to accommodate the region 610. Thus, at the bottom portion of the list positioning scenario 700, a linear list window 706 is displayed such that a topmost item 708 of the list items 604 is displayed at the pre-selection position of the selectable item 602. For example, when the linear list window 706 is drawn, the topmost item 708 occupies the same position on the display screen 612 that the selectable item 602 occupied prior to the linear list window being drawn. This enables the linear list window to accommodate all of the list items 604 in the display screen.

While not expressly illustrated here, a similar situation can occur if there is insufficient room below the selectable item 602 to include list items that fall below the selectable item 602 in the list items 604, e.g., list items from the zone 610. In such a scenario, a linear list window can be drawn such that a bottommost item in the list items 604 occupies the same position on the display screen 612 that the selectable item 604 occupied prior to the linear list window being drawn. Thus, a position of a linear list window can shift to accommodate various positions of a selectable item within a display area.

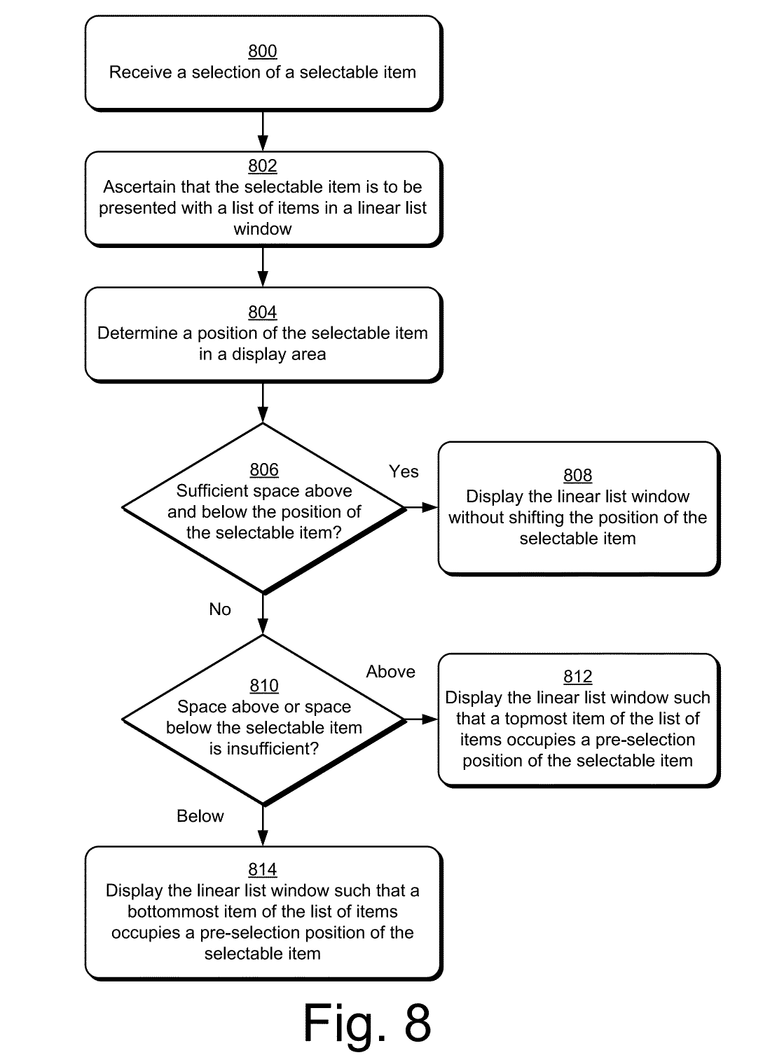

FIG. 8 is a flow diagram that describes steps in a method in accordance with one or more embodiments. In at least some embodiments, the method can be implemented by a list module, such as the one described in FIG. 1. Step 800 receives a selection of a selectable item. Step 802 ascertains that the selectable item is to be presented with a list of items in a linear list window. Examples ways of determining that a linear list window is to be presented are discussed above.

Step 804 determines a position of the selectable item in a display area. For example, the position can be determined with respect to the pixel positions (e.g., the borders) of the selectable item with reference to the bounds of the display area. Step 806 ascertains whether there is sufficient space above and below the position of the selectable item to present the linear list window without shifting the position of the selectable item. Example ways of making this determination are discussed above.

If there is sufficient space above and below (“Yes”), step 808 displays the linear list window without shifting the position of the selectable item. If there is not sufficient space (“No”), step 810 determines which of the space above or space below the selectable item is insufficient. If the space above the selectable item is insufficient (“Above”), step 812 displays the linear list window such that a topmost item of the list of items occupies a pre-selection position of the selectable item. If the space below the selectable item is insufficient (“Below”), step 814 displays the linear list window such that a bottommost item of the list of items occupies a pre-selection position of the selectable item.

Having discussed some example implementations that that position linear windows, consider now some example implementations that position wrapped windows in accordance with one or more embodiments.

Positioning Wrapping Windows

The logic involved in positioning a wrapping list window in a user interface varies somewhat from that for linear list windows. Examples of such logic are discussed hereafter.

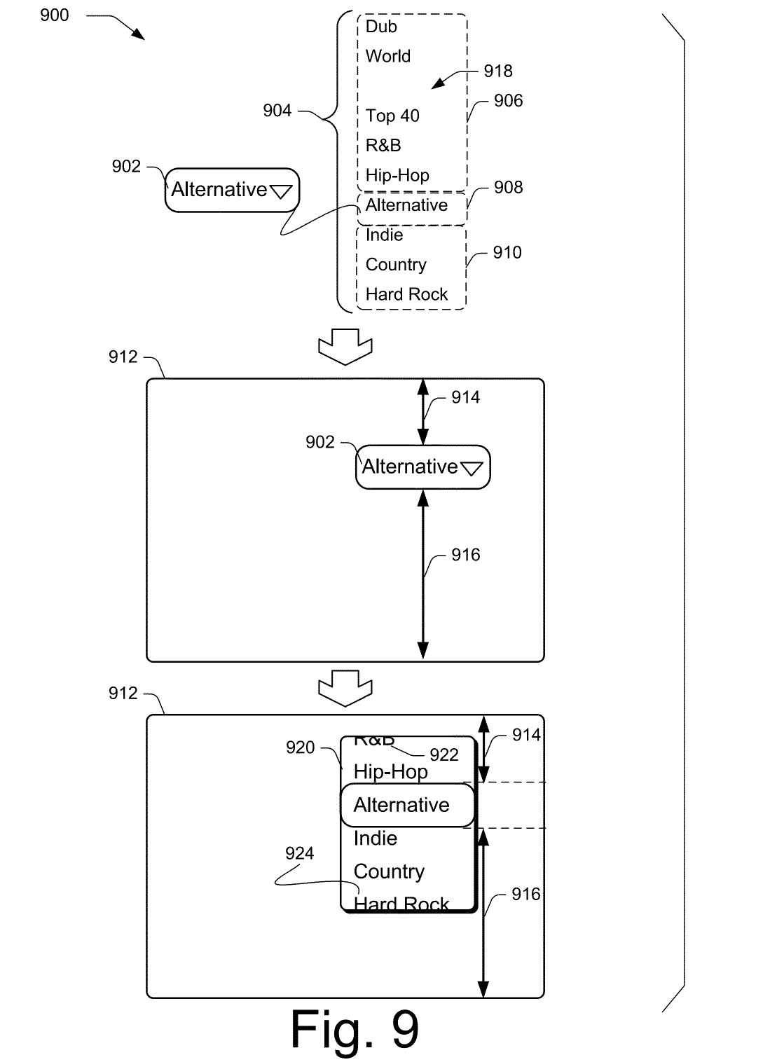

FIG. 9 illustrates an example list positioning scenario 900 in accordance with one or more embodiments. Illustrated at the top portion of the list positioning scenario 900 is a selectable item 902, which is part of a list of items 904. The list items 904 are divided into three zones. A zone 906 includes list items that occur above the selectable item 902 in the list items 904. A zone 908 refers to the position of the selectable item 902 in the list items 904. Finally, a zone 910 includes list items that are positioned below the selectable item 902 in the list items 904. The illustrated zones are presented for purpose of example only, and any suitable type and/or size of zone may be implemented in accordance with the claimed embodiments.

Continuing to the center portion of the list positioning scenario 900, the selectable item 902 is displayed on a display screen 912, e.g., included as part of the computing device 102. In response to a selection of the selectable item 902, a determination is made where to position a wrapping list window that includes the list items 904.

To determine where to position the wrapping list window, a region 914 between the top edge of the selectable item 902 and the top edge of the display screen 912 is measured. Additionally, a region 916 between the bottom edge of the selectable item 902 and the bottom edge of the display screen 912 is measured. In drawing a wrapping list, the position of the selectable item 902 will remain unchanged from its original selection position. Thus, a determination is made how to position the remaining list items 904 around the selectable item 902 in a wrapping list.

With reference to populating items from the zone 906 into the region 914, we first consider the threshold number of items on which the wrapping list window is based, e.g., as discussed above with reference to FIG. 5. This is designated as a list threshold. Next, a zone threshold number of list items from the zone 906 is defined based on the list threshold. For example, we take the list threshold and subtract one, and divide this by two to obtain the zone threshold. For purposes of the illustrated example, we will define the list threshold as 7. Applying the list threshold to the previous equation, a zone threshold of 3 is derived. These thresholds are presented for purposes of example only, and any suitable threshold may be utilized within the spirit and scope of the claimed embodiments.

Next, two different rules are applied. First, list items 904 from the zone 906 are used to populate the region 914 until either the top edge of the display screen or the zone threshold number of list items (e.g., 4) is reached with a cropped list item, whichever occurs first. Remaining list items 904 from the zone 906 are not displayed in the region 914 and can be accessed by scrolling and/or panning the list items in the wrapping list window.

With reference to the second rule, the total number of list items 904 is defined as “x.” The second rule provides that a maximum of (x−2)/2 items from the zone 906 can be added to the region 914, including a list separator as a list item. This enables at least one item to be presented above the selectable item 902 in the wrapped list, as well as at least one item to remain out of view that can be navigated to via scrolling the wrapped list. With reference to the current example, the total number of list items 904 is 10, including a list separator 918. Thus, applying the second rule provides that a maximum of (10−2)/2, or 4 list items, can be used to populate the region 914.

Within the bounds specified by the rules above, if all of the list items from the zone 906 will fit in the region 914, then these list items are displayed in the region 914 with the topmost item cropped. If some of the list items from the zone 906 don't fit within the region 914, then the closest item within the defined bounds to the selectable item 902 is cropped at the top edge of the wrapped list.

With reference to populating items from the zone 910 into the region 916, the same rules and thresholds are applied as with the zone 906, except with reference to the bottom edge of the display screen 912.

Thus, continuing to the bottom portion of the list positioning scenario 900, a wrapping list window 920 is drawn based on the rules above. List items 904 from the zone 906 are added to the region 914 until the top of the display screen 912 is reached, allowing for a cropped list item 922. Further, list items from the zone 910 are added to the region 916. In this example, all of the list items from the zone 910 fit within the region 916, and thus these list items are added to the region 916 with a cropped list item 924.

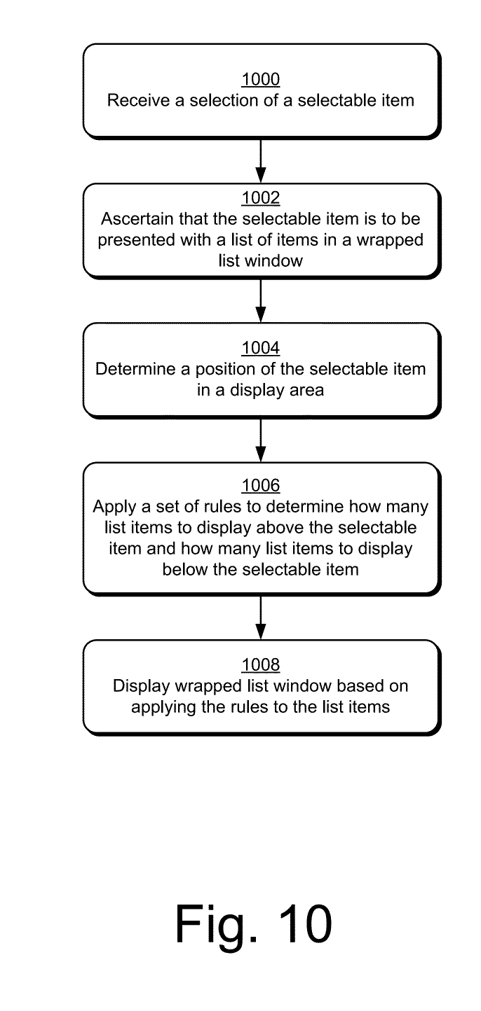

FIG. 10 is a flow diagram that describes steps in a method in accordance with one or more embodiments. In at least some embodiments, the method can be implemented by a list module, such as the one described in FIG. 1. Step 1000 receives a selection of a selectable item. Step 1002 ascertains that that the selectable item is to be presented with a list of items in a wrapped list window. Example ways of determining whether a wrapped list window or a different type of window is to be presented are discussed above.

Step 1004 determines a position of the selectable item on a display screen. For example, the position can be with respect to pixel coordinates, vector positions, and so on. Step 1006 applies a set of rules to determine how many list items to display above the selectable item and how many list items to display below the selectable item. Examples of such rules are discussed in detail above. Step 1008 displays a wrapping list window based on applying the rules to the list items.

Having described example list positioning scenarios and methods, consider now an example system and an example device that can be utilized to implement one more embodiments described above.

Example System and Device

FIG. 11 illustrates an example system showing the list module 104 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices.

For example, as previously described the computing device 102 may be configured in a variety of different ways, such as for mobile 1102, computer 1104, and television 1106 uses. Each of these configurations has a generally corresponding screen size and thus the computing device 102 may be configured as one of these device classes in this example system 1100. For instance, the computing device 102 may assume the mobile 1102 class of device which includes mobile telephones, music players, game devices, and so on. The computing device 102 may also assume a computer 1104 class of device that includes personal computers, laptop computers, netbooks, and so on. The television 1106 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 1108 is illustrated as including a platform 210 for web services 212. The platform 1110 abstracts underlying functionality of hardware (e.g., servers) and software resources of the cloud 1108 and thus may act as a “cloud operating system.” For example, the platform 1110 may abstract resources to connect the computing device 102 with other computing devices. The platform 1110 may also serve to abstract scaling of resources to provide a corresponding level of scale to encountered demand for the web services 1112 that are implemented via the platform 1110. A variety of other examples are also contemplated, such as load balancing of servers in a server farm, protection against malicious parties (e.g., spam, viruses, and other malware), and so on.

Thus, the cloud 1108 is included as a part of the strategy that pertains to software and hardware resources that are made available to the computing device 102 via the Internet or other networks. For example, the list module 104 may be implemented in part on the computing device 102 as well as via a platform 210 that supports web services 212.

For example, the techniques supported by the list module 104 may implemented via input detected using touchscreen functionality in the mobile configuration 1102, track pad functionality of the computer 1104 configuration, detected by a camera as part of support of a natural user interface (NUI) that does not involve contact with a specific input device, and so on. Further, performance of the operations to detect and recognize the inputs to identify a particular gesture may be distributed throughout the system 1100, such as by the computing device 102 and/or the web services 1112 supported by the platform 1110 of the cloud 1108.

FIG. 12 illustrates various components of an example device 1200 that can be implemented as any type of portable and/or computer device as described with reference to FIGS. 1 and 11 to implement embodiments of the techniques for interaction with lists described herein. Device 1200 includes communication devices 1202 that enable wired and/or wireless communication of device data 1204 (e.g., received data, data that is being received, data scheduled for broadcast, data packets of the data, etc.). The device data 1204 or other device content can include configuration settings of the device, media content stored on the device, and/or information associated with a user of the device. Media content stored on device 1200 can include any type of audio, video, and/or image data. Device 1200 includes one or more data inputs 1206 via which any type of data, media content, and/or inputs can be received, such as user-selectable inputs, messages, music, television media content, recorded video content, and any other type of audio, video, and/or image data received from any content and/or data source.

Device 1200 also includes communication interfaces 1208 that can be implemented as any one or more of a serial and/or parallel interface, a wireless interface, any type of network interface, a modem, and as any other type of communication interface. The communication interfaces 1208 provide a connection and/or communication links between device 1200 and a communication network by which other electronic, computing, and communication devices communicate data with device 1200.

Device 1200 includes one or more processors 1210 (e.g., any of microprocessors, controllers, and the like) which process various computer-executable or readable instructions to control the operation of device 1200 and to implement the embodiments described above. Alternatively or in addition, device 1200 can be implemented with any one or combination of hardware, firmware, or fixed logic circuitry that is implemented in connection with processing and control circuits which are generally identified at 1212. Although not shown, device 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1200 also includes computer-readable media 1214, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1200 can also include a mass storage media device 1216.

Computer-readable media 1214 provides data storage mechanisms to store the device data 1204, as well as various device applications 1218 and any other types of information and/or data related to operational aspects of device 1200. For example, an operating system 1220 can be maintained as a computer application with the computer-readable media 1214 and executed on processors 1210. The device applications 1218 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 1218 also include any system components or modules to implement embodiments of the techniques described herein. In this example, the device applications 1218 include an interface application 1222 and a gesture-capture driver 1224 that are shown as software modules and/or computer applications. The gesture-capture driver 1224 is representative of software that is used to provide an interface with a device configured to capture a gesture, such as a touchscreen, track pad, camera, and so on. Alternatively or in addition, the interface application 1222 and the gesture-capture driver 1224 can be implemented as hardware, software, firmware, or any combination thereof.

Device 1200 also includes an audio and/or video input-output system 1226 that provides audio data to an audio system 1228 and/or provides video data to a display system 1230. The audio system 1228 and/or the display system 1230 can include any devices that process, display, and/or otherwise render audio, video, and image data. Video signals and audio signals can be communicated from device 1200 to an audio device and/or to a display device via an RF (radio frequency) link, S-video link, composite video link, component video link, DVI (digital video interface), analog audio connection, or other similar communication link. In an embodiment, the audio system 1228 and/or the display system 1230 are implemented as external components to device 1200. Alternatively, the audio system 1228 and/or the display system 1230 are implemented as integrated components of example device 1200.

### CONCLUSION

Techniques for interaction with lists are described. Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method comprising:
receiving a selection of a selectable item displayed on a display screen;
presenting a list of items in a wrapped list window on the display screen visually centered on the selectable item in response to the selection; and
scrolling the list of items as a wrapped list, said selection and said scrolling occurring as part of a single user interaction with the display screen.

2. The method of claim 1, wherein said selection comprises a touch selection, and where said single user interaction comprises a single user touch interaction.

3. The method of claim 1, wherein said presenting comprises presenting the list of items in the wrapped list window such that a position of the selectable item on the display screen prior to said presenting corresponds to a position of the selectable item in the wrapped list window.

4. The method of claim 1, wherein said presenting comprises drawing the wrapped list window such that edges of the wrapped list window animate outwardly from a center point relative to the selectable item.

5. The method of claim 1, further comprising displaying a list separator in the wrapped list window that visually emphasizes a separation between a first item of the list of items and a last item of the list of items in the wrapped list.

6. The method of claim 1, wherein said presenting is responsive to a determination that a number of items in the list of items exceeds a threshold number of list items.

7. The method of claim 1, wherein said presenting is based on logic for presenting wrapped list windows, the logic comprising:
dividing the list of items into at least a first zone that includes items that occur above the selectable item in the list of items, and a second zone that includes items that occur below the selectable item in the list of items;
defining a zone threshold that indicates a maximum number of items that can be displayed from one or more of the first zone or the second zone;
populating a region above the selectable item in the wrapped list window with items from the first zone until the first of:
all items from the first zone are displayed;
the zone threshold is reached; or
an upper edge of the display screen is reached; and
populating a region below the selectable item in the wrapped list window with items from the second zone until the first of:
all items from the second zone are displayed;
the zone threshold is reached; or
a lower edge of the display screen is reached.

8. The method of claim 7, wherein said logic specifies one or more of at least one item from the first zone is to be visually cropped in the region above the selectable item, or at least one item from the second zone is to be visually cropped in the region below the selectable item.

9. One or more computer readable storage media embodying computer readable instructions which, when executed, implement a method comprising:
presenting, in response to a selection of a selectable item, a list of items in a wrapped window on a display screen such that the list of items are visually centered on the selectable item;
displaying a list separator that visually emphasizes a separation between a last item of the list of items and a first item of the list of items in a wrapped list; and
scrolling the list of items in the wrapped list, said selection and said scrolling occurring as part of single user interaction with the display screen.

10. The one or more computer readable storage media of claim 9, wherein said list separator comprises a null item inserted between the last item and the first item.

11. The one or more computer readable storage media of claim 9, wherein said list separator is associated with speed bump functionality that causes a speed of the scrolling to slow in response to the list separator reaching one or more of a top of the wrapped window or a bottom of the wrapped window.

12. The one or more computer readable storage media of claim 9, wherein said scrolling causes the list separator to exit the wrapped window from a first edge, and reenter the wrapped window from a second edge opposite the first edge.

13. The one or more computer readable storage media of claim 9, wherein said presenting comprises determining that the wrapped window is to be presented based on determining that the display screen is not large enough to display a threshold number of items plus an additional item in a list window.

14. The one or more computer readable storage media of claim 9, wherein said presenting comprises displaying the selectable item in a same position on the display screen that the selectable item occupied prior to the selection.

15. The one or more computer readable storage media of claim 9, wherein said presenting is based on logic associated with the wrapped window, the logic specifying how to place items of the list of items in the wrapped window based on a position of the selectable item in the display screen.

16. A system comprising:
one or more computer-readable storage media;
a module embodied on the one or more computer-readable storage media, the module being configured to implement a method comprising:
ascertaining that a list of items is to be displayed on a display screen;
determining whether a number of items in the list of items exceeds a threshold number of items;
in response to determining that the number of items exceeds the threshold, presenting the list of items as a wrapped list according to a set of wrapped list logic;
in response to determining that the number of items does not exceed the threshold, determining whether the display screen is large enough to display the threshold number of items plus an additional item;
responsive to a determination that the display screen is large enough to display the threshold number of items plus the additional item, displaying the list of items in a linear list window according to a set of linear list logic; or
responsive to a determination that the display screen is not large enough to display the threshold number of items plus the additional item, displaying the list of items in the wrapped list window according to the set of wrapped list logic.

17. The system of claim 16, wherein said ascertaining is responsive to a touch selection of a selectable item included in the list of items, the method further comprising receiving the touch selection and scrolling the list of items in one of the linear list window or the wrapped list window as part of a single touch interaction with the display screen.

18. The system of claim 16, wherein the threshold number of items is based at least in part on a size of the display screen.

19. The system of claim 16, wherein said ascertaining is responsive to a touch selection of a selectable item included in the list of items and displayed on the display screen, and wherein the linear list logic specifies that a position of the linear list window on the display screen is based on a number of items that occur above the selectable item in the list of items, or a number of items that occur below the selectable item in the list of items.

20. The system of claim 19, wherein said displaying the list of items in a linear list window comprises shifting a position of the linear list window in response to:
determining that the number of items that occur above the selectable item do not fit in a region of the display screen above the selectable item; or
determining that the number of items that occur below the selectable item do not fit in a region of the display screen below the selectable item.
